(19) United States
(12) Patent Application Publication
(10) Pub. No.: US 2014/0174787 A1
(43) Pub. Date: Jun. 26, 2014

(54) INSULATOR FOR HIGH-VOLTAGE GAS INSULATED SWITCH GEAR

(71) Applicant: ABB RESEARCH LTD, Zurich (CH)

(72) Inventors: Nikolaus Zant, Zurich (CH); Dariusz Bednarowski, Krakow (PL); Robert Platek, Krakow (PL); Harald Martini, Vasteras (SE); Ralph Uhl, Frankfurt (DE); Michael Mann, Alzenau (DE); Cherif Ghoul, Mulhouse (FR); Malinowski Lukasz, Krakow (PL)

(73) Assignee: ABB RESEARCH LTD, Zurich (CH)

(21) Appl. No.: 14/193,399

(22) Filed: Feb. 28, 2014

Related U.S. Application Data
(63) Continuation of application No. PCT/EP2012/067041, filed on Sep. 2, 2012.
(60) Provisional application No. 61/530,668, filed on Sep. 2, 2011.

(51) Int. Cl. H01B 17/00; H01B 13/06

(52) U.S. Cl. CPC H01B 17/00; H01B 13/06
USPC 174/111; 425/129.1; 264/279

(57) ABSTRACT

An insulator for a gas insulated device and method of making and/or producing the insulator are disclosed. The insulator includes an injection molded insulator disc and a conductor. The insulator disc includes a center opening encompassed by an inner bead inside which the conductor is arranged. The insulator disc includes, for example, a first material which is injection molded onto the conductor.

### RELATED APPLICATION(S)

This application claims priority as a continuation application under 35 U.S.C. §120 to PCT/EP2012/067041, which was filed as an International Application on Sep. 2, 2012, designating the U.S., and which claims priority to U.S. Application No. 61/530,668 filed in the United States on Sep. 2, 2011. The entire contents of these applications are hereby incorporated herein by reference in their entireties.

### FIELD

The disclosure relates to an insulator for a gas insulated device, for example, to an insulator including an insulator disc surrounding a high voltage conductor, a gas insulated device including such an insulator, and methods of producing such an insulator.

BACKGROUND INFORMATION

A gas-insulated switchgear (GIS) can accommodate high-voltage conductors such as lead conductors to which a high voltage can be applied. In order to shield and insulate the high-voltage conductor from other components and from the outside, such an apparatus can include a grounded metal enclosure filled with an insulating gas, for example, a dielectric gas such as SF6.

In order to hold a high-voltage conductor firmly inside the device volume, in a position sufficiently far away from the grounded enclosure such as to avoid dielectric breakdowns, an insulator can be provided inside the GIS enclosure. The insulator can be secured at its outer edge to the enclosure, and can have a central opening for accommodating the high-voltage conductor. The main portion of the spacer can be an insulator disc, with the opening at its center. Some spacers may have a metal armature ring attached to the outer circumference of the insulator disc. The armature ring may have attachment means such as thread holes, which can allow the insulator disc to be firmly attached to the GIS enclosure.

Alumina filled epoxy has been used in the manufacturing of insulators in GIS. Epoxy can be a material, which has good electrical insulating properties and mechanical strength. Epoxy is not environment friendly and the manufacturing process (molding) can be complicated, time consuming, and therefore relatively costly. The material of epoxy insulators can also be inherently brittle. This brittleness may lead to an unwanted sudden failure if loaded too high and therefore should be controlled closely to ensure proper part function. The manufacturing process can be complex, and a stable production can be important for good part quality.

EP2273641 was filed in the name of ABB Technology AG and published in January 2011, and discloses a spacer for a gas insulated device. The spacer includes an insulator disc and an armature extending around an outer periphery of the insulator disc and foreseen to hold the insulator disc. For producing the spacer, an armature can be positioned in a first molding cavity of a molding machine such that a second molding cavity can be formed. An insulation material can be brought into the second cavity and then cured such that the armature holds the insulator disc therein thus forming the insulator. The armature ring of an insulator may have a through channel (see [0056] and FIG. 13) extending across the ring in a radial direction and used for casting the mold.

JP2006340557A was filed in the name of Mitsubishi Electric Corp. and published in December 2006, and is directed to a disc-like member composed of an injection molded insulator. The leakage of insulating gas can be blocked by an O-ring fitted in an annular groove. The O-ring can be prevented from falling when the instrument is assembled in that it is fitted in an annular groove formed around the central axis of the disc-like member.

JP2004104897A was filed in the name of Fuji Electronic Holding Ltd., and is directed to the production of a spacer for a gas-insulated electrical apparatus using thermoplastic resin which can be easily recycled. An insulation body of the spacer can be divided into a plurality of layers in the axial direction of a conductor. Each of the layers can be formed using a thermoplastic resin and the divided bodies can be integrally combined. By dividing an insulation body, the thickness of each of the divided bodies can be made reduced, thus enabling injection molding by the thermoplastic resin of each of the divided bodies. The layers can be combined so as to be in a hollow shell condition, and partially or totally jointed by adhesion, fitting, or fusing, thus obtaining required mechanical strength and insulation strength. One drawback of this solution can be that the insulator tends to include inclusions which are taking influence on the electrical field. A further drawback can be the difficulty in the production of the product.

U.S. Pat. No. 4,458,100 was assigned to Westinghouse Electric Corp. and published in 1984. U.S. Pat. No. 4,458,100 is directed to a gas insulated transmission line having an insulator for supporting an inner conductor concentrically within an outer sheath. A common insulator can be used for supporting the inner high voltage conductor within the outer conductor. A material, such as epoxy, can be selected which has a coefficient of expansion similar to the metal selected for the inner conductor so as to minimize the possibility of voids being formed at the critical interface where the insulator meets the conductor.

U.S. Pat. No. 4,263,476 was assigned to Electric Power Research Institute and published in 1979. U.S. Pat. No. 4,263,476 is directed to an injection molded insulator with a single insulator structure, which can be used in an elongated flexible gas-insulated cable. The insulator can be made of two halves which are latched together and can be made of any suitable plastic material by an injection molding process. It is described that the insulator would preferably be used in a flexible gas-insulated cable for a high voltage transmission system having a relatively low frequency (60 Hertz) at high voltage (345′000 volts). The central conductor of the cable can be supported by the insulator within an outer corrugated housing. The housing can be filled with an electronegative gas, such as SF6 at a positive pressure, for example, two to three atmospheres.

EP2062268 was filed in the name of Areva SA., and was published in March 2008. EP2062268 is directed to an insulating support for a high-voltage or medium-voltage device. The insulating support can be based on an insulating polymeric material including at least at one of its ends a zone including a composite material including a matrix made of an insulating polymeric material with an electrically conducting filler which is a polymeric filler possibly encapsulating a mineral filler.

U.S. Pat. No. 7,795,541 B was assigned Areva AG. U.S. Pat. No. 7,795,541 B was published in 2006 and relates to an insulating device for medium or high voltage electrical equipment in the shape of a disc inside an enclosure acting as a support for an electrical conductor. The disc can be made of thermoplastic polyester. The disc can be worked starting from a thick board using conventional machining tools and it can be provided with particular arrangements, for example to facilitate its assembly or connection of conductors supported on it.

### SUMMARY

An insulator for a gas insulated device is disclosed, the insulator comprising: an injection molded insulator disc; and a conductor, the insulator disc including a center opening encompassed by an inner bead inside which the conductor is arranged and an outer bead encompassing the insulator disc, and wherein the insulator disc is formed of a first material which is injection molded onto the conductor.

A method for the production of an insulator is disclosed, the method comprising: providing a mold for injection molding of an insulator disc, the insulator disc comprising an inner bead surrounding a center opening; arranging a conductor in a cavity of the mold; injecting a first material into the mold to form the insulator disc, wherein the conductor is positioned inside of the center opening and the inner bead of the insulator disc and the conductor are firmly interconnected directly or indirectly; and removing of the insulator disc and the conductor from the mold.

A method for making of an insulator disc, the insulator disc having a center opening and an inner bead and an outer bead, and a conductor arranged in the center opening of the insulator disc is disclosed, the method comprising: providing an injection mold, the injection mold having a first mold half, a second mold half interacting with the first mold half along a parting plane, a cavity corresponding to the insulator encompassed by the first and the second mold half, and at least one injection nozzle arranged at the first mold half configured to discharge liquefied material into the cavity directly or indirectly; closing the mold by relative movement of the first with respect to the second mold half until the cavity is closed; injecting liquefied material through the at least one injection nozzle; opening the mold by relative movement of the first with respect to the second mold half; and removing the insulator from the mold cavity.

### BRIEF DESCRIPTION OF THE DRAWINGS

The disclosure is explained below with reference to exemplary embodiments shown in the drawings. In the drawings:

FIG. 1 shows a perspective view of an exemplary embodiment of an insulator;

FIG. 2 shows a front view of the exemplary embodiment of the insulator of FIG. 1;

FIG. 3 shows a section view of the exemplary embodiment along section line 3-3 according to FIG. 2;

FIG. 4 shows a perspective view of an exemplary embodiment of an insulator;

FIG. 5 shows a perspective view of an exemplary conductor of the insulator of FIG. 4;

FIG. 6 shows a front view of the exemplary embodiment of the insulator of FIG. 4;

FIG. 7 shows a section view of the exemplary embodiment along section line 7-7 according to FIG. 6;

FIG. 8 shows a perspective view of an exemplary embodiment of an insulator;

FIG. 9 shows a front view of the exemplary embodiment of the insulator of FIG. 8;

FIG. 10 shows a section view of the exemplary embodiment along section line 10-10 according to FIG. 9;

FIG. 11 shows a perspective view of a partial cutaway of the exemplary embodiment as shown in FIG. 8;

FIG. 12 shows a perspective view of a partial cutaway of the exemplary embodiment as shown in FIG. 8 with a second material component;

FIG. 13 shows a perspective view of an exemplary embodiment of an insulator;

FIG. 14 shows a front view of the exemplary embodiment of the insulator of FIG. 13;

FIG. 15 shows a section view of the exemplary embodiment along section line 15-15 according to FIG. 14;

FIG. 16 shows a perspective view of an exemplary embodiment of an insulator;

FIG. 17 shows a front view of the exemplary embodiment of the insulator of FIG. 16;

FIG. 18 shows a section view of the exemplary embodiment along section line 18-18 according to FIG. 17;

FIG. 19 shows a perspective view of an exemplary embodiment of an insulator;

FIG. 20 shows a front view of the exemplary embodiment of the insulator of FIG. 19;

FIG. 21 shows a section view of the exemplary embodiment along section line 21-21 according to FIG. 20;

FIG. 22 shows a perspective view of an exemplary embodiment of an insulator;

FIG. 23 shows a front view of the exemplary embodiment of the insulator of FIG. 22; and

FIG. 24 shows a section view of the exemplary embodiment along section line 24-24 according to FIG. 23.

### DETAILED DESCRIPTION

The present disclosure is directed to an insulator for electrical insulation, for example, in switchgear such as a gas insulated device, wherein the insulator can include an injection molded insulator disc and a conductor. The insulator disc includes a center opening encompassed by an inner bead inside which the conductor can be arranged. The insulator disc consists out of a material which can be injection molded onto the conductor.

The insulator can be made out of a thermoplastic material. For example, the thermoplastic material used can be of ductile nature and therefore more fail safe. At least the insulator disc can be produced by injection molding, which can provide the following: reduced cycle time, increased degree of automation and less complicated material preparation. However, the wall thickness may be limited, for example, less than 10 mm.

The insulator disc may include structural components, such as ribs or other reinforcement means to increase stiffness and durability. The insulator disc may be built-up by a multi-stage injection molding process where structural parts and/or different materials can be integrally combined to form the insulator disc or part of it.

In an exemplary embodiment the insulator can include an injection molded insulator disc and a conductor. The insulator disc can include a center opening encompassed by an inner bead inside which the conductor can be arranged. If appropriate the insulator disc can include an outer bead encompassing the insulator disc. The insulator disc can be injection molded onto the conductor. In an exemplary embodiment, the insulator disc can be directly injection molded onto an outer surface of the conductor. Alternatively, or in addition, an intermediate layer can be arranged between the conductor and the insulator disc. The intermediate layer can be, for example, a primer. The conductor may include teeth, which can be directly or indirectly engaged with the insulator disc for form fit. An example of an indirect connection, can be a conductor that is already coated with a field electrode, for example, prior to inserting the coated conductor into the cavity of the mold. The term ‘teeth’ shall not be understood as a jagged structure in a narrow sense since sharp edges shall be avoided for dielectric reasons. The term ‘teeth’ shall be rather understood in a broad sense as a representative term for any suitable locking means for establishing a form fit by a variation in diameter relative to the center axis of the insulator. That engaging means blocks the insulator body from being stripped off the conductor in an axial direction easily, for example, in the direction of the center axis of the insulator. In an exemplary embodiment, the locking means can include one single rounded tooth that can be established by a bulge extending circumferentially and radially on the shell surface of the conductor. After injection molding of the insulator body/disc, the insulator body/disc features in its center opening a shape being the negative to the bulge such that a good form fit in between the conductor and the insulator disc can be achievable. Moreover, the locking means can serve for increasing an overall contact surface in between the conductor and the insulator disc.

The inner bead can at least partially be distanced by a gap from the conductor. A transition means can be arranged in the gap interconnecting the inner bead and the conductor. A holding means may be arranged inside the gap positioning the conductor with respect to the insulator disc. The holding means may be at least one circumferential holding rib and/or at least one holding rib arranged in axial direction (axial holding rib). The holding means may be integrally connected to the insulator disc. The first material may be injected by at least one first distribution channel arranged within the conductor. The term ‘first material’ shall not be understood narrow in that it consists of one single material such as PET, for example, but broad in that it may be a material composition. However, a more detailed explanation will follow in this disclosure.

The insulator disc may include a bridge element for uniform distribution of the material, whereby the bridge element can be arranged between the first distribution channel and the inner bead. On the inside of the bridge element, a circumferential channel may be arranged for distribution of material in a circumferential direction. The conductor may include at least one second distribution channel arranged within the conductor by which a second material for forming of the transition means can be injected. The second material for forming of the transition means may be inserted into the axial gap by a robot. The transition means may be mechanically interconnected (form fit) to the insulator disc and/or the conductor. The inner and/or the outer bead can be a strut by ribs. The ribs and the wall may have in general the same wall thickness. At least one cross-port may extend between two ribs in axial direction. The ribs may have an evenly distributed setup with respect to the center opening. At least one middle bead may be arranged concentric to the inner and/or the outer bead. The ribs may have a curved shape. The ribs may be arranged at an angle with respect to a center axis of the conductor. The ribs may be arranged in a radial direction. The ribs may be arranged alternatively with respect to the insulator disc. The insulator disc may be encompassed by a flange made out of a conductive material. At least one field control element may be embedded in the insulator disc. The at least one field control element may be electrically interconnected to the conductor or the flange by a connecting element. At least one seal may be attached to the insulator disc. The at least one seal may be joint to the insulator disc by injection molding of the at least one seal onto the insulator disc. The transition means can be made out of or include a conductive material for acting as a filed control element.

A method for the production of an insulator according to the disclosure can include the following steps:

a) providing a mold for injection molding of an insulator disc including an inner bead surrounding a center opening;

b) arranging inside of the mold a conductor in a defined position;

c) injecting of a first material into the mold to form the insulator disc, such the conductor can be positioned inside of the center opening and the inner bead of the insulator disc and the conductor are firmly interconnected directly or indirectly. An example of an indirect interconnection, which can be achievable is a conductor that is already coated with a field electrode, for example, prior to inserting the coated conductor into the cavity of the mold such that the conductor is held via the field electrode in the insulator disc; and

d) removing of the insulator disc and the conductor from the mold.

The first material can be injected through at least one channel arranged inside the conductor. The second material may be injected through a channel arranged inside the conductor and/or by direct injection into the gap. The conductor may be preheated to a defined temperature before step before injection of the first material. The mold may include appropriate means, for example, in the form of appropriate connection channels, to interconnect to at least one of the channels arranged in the conductor. Alternatively, or in addition the mold can be designed such that the conductor can be directly accessible from the outside, for example, the mold can includes an opening through which the conductor, respectively the channels arranged in the conductor, can be accessible from the outside when the conductor is arranged inside of the closed mold. The mold may include an adapter to receive and temporarily hold the conductor during the injection molding process. The adapter may be designed exchangeable such that different conductors can be processed with the same mold. The adapter can be part of the cavity of the mold thereby being at least partially in contact with the injection molded material.

A mold for making of an insulator disc can include: a first mold half, a second mold half interacting with the first mold half along a parting plane, at least one cavity corresponding to an insulator disc encompassed by the first and the second mold half. The mold may further include at least one adapter suitable to receive and temporarily hold a conductor during injection molding of the insulator disc, at least one injection nozzle arranged at the first mold half discharging directly or indirectly into the at least one cavity. Depending on the field of application and the design of the insulator can use at least two different injection nozzles to inject the material. The injection mold may include at least one adapter, which may form part of one of the mold halves. The at least one adapter may have a general cylindrical shape. The at least one adapter may include clamping means to temporarily receive and hold the conductor. The at least one adapter may be arranged displaceable independent of a movement of the mold halves. The at least one adapter may be arranged displaceable against the force of a spring. The insulator disc can be produced independent of the conductor, for example, by using a dummy, which is later replaced by the conductor. The dummy can be placed in the mold instead of the adapter. The area forming the inside of the insulator disc can be completely integrated in the mold. The injection mold may include at least one ejector. The ejector can be arranged at the second mold half to eject the insulator from the injection mold. The at least one ejector may be arranged in the region of and acting upon the outer rim of the insulator disc. Alternatively, or in addition, the at least one ejector may be arranged in the region of and acting upon conductor of the insulator disc. Further ejectors may be arranged in-between.

The at least one injection nozzle may discharge into the cavity in the area of the outer rim of insulator disc. Furthermore, alternatively, or in addition, the at least one injection nozzle may discharge into the cavity through at least one channel arranged in the conductor and/or another mold part. Alternatively, or in addition, the at least one injection nozzle may discharge into the cavity through at least one gap designed to act as a film gate. The at least one gap may be interconnected to a chamber into which the material is discharged first. The at least one gap may have a variable geometry in circumferential direction and/or have several segments.

In an exemplary embodiment, the material can be injected by at least one first distribution channel arranged at a circumferential position with respect to the insulator disc. The distribution channel at least partially encompasses the insulator disc. The distribution channel may be separated in segments.

A method for making of an insulator disc as described above in general can include the following method steps:

a. providing an injection mold having:
i. a first mold half;
ii. a second mold half interacting with the first mold half along a parting plane;
iii. a cavity corresponding to the insulator encompassed by the first and the second mold half;
iv. at least one injection nozzle arranged at the first mold half suitable to discharge liquefied material into the cavity directly or indirectly;

b. closing the mold by relative movement of the first with respect to the second mold half until the cavity is closed;

c. injecting liquefied material through the at least one injection nozzle;

d. opening the mold by relative movement of the first with respect to the second mold half (16, 17); and

e. removing the insulator from the mold cavity (17).

In accordance with an exemplary embodiment, the mold can include at least one adapter suitable to receive and temporarily hold a conductor during injection molding of the insulator disc. In this case, before injecting the liquefied material into the cavity, the mold can be opened by relative movement of the first mold half with respect to the second mold half in a first direction. Then a conductor can be attached to the at least one adapter and the mold can be subsequently closed.

At least one part of the mold may be arranged movable to reduce the volume of the cavity and thereby compressing the material in the cavity after and/or during injection of the liquefied material. By this compression step the quality of the surface of the insulator disc can be improved. The compression step can be performed by relative movement of the mold halves from a first into a second closing position. Alternatively, or in addition, at least one segment of at least one of the mold halves can be designed movable independent of the movement of the mold halves. For example, a ring like segment in the area of the outer bead can be arranged moveable for the compression step to avoid parting lines in the functional critical area of the insulator disc.

The injection compression molding process can further increase the advantages of the injection molding process, for example, by helping reduce the residual stress in the part through the evenly distributed pressure throughout the mold cavity during the compression step. The pressure distribution can also lead to a superior surface quality, for example, when used in combination with a mirror polished mold cavity surface. In accordance with an exemplary embodiment, an insulator surface having a surface roughness that is as low as possible resides in that the electric field is locally less intensified at the insulator surface compared to an insulator surface having a higher roughness. Hereinafter, the term surface roughness is to be understood as the surface quality, for example, the amount of the vertical deviations of a real surface from its ideal form. These deviations relate to the size and the number of peaks/valleys on the surface of a body in general. If these deviations are large, for example, the surface can be rough; if the deviations are small, the surface can be smooth. The lower the surface roughness value is, the lower locally intensified the electric fields are once the insulator disc is in an operating state of the high voltage gas insulated device. This explanations relating to the effects arising of the injection compression molding is not limited to this exemplary embodiment and applies likewise to all exemplary embodiments disclosed in the present application.

The at least one ejector can be activated to eject the insulator from the injection mold. The several injection nozzles may be arranged in at least one concentric row or at least one group around the center of the mold. The several injection nozzles may be activated simultaneously or in a sequence, for example, in that at least two injection nozzles are activated at different times to obtain uniform material distribution. An outer surface of the conductor may be treated by a surface treatment and/or coated by a coating material to increase bonding of the material injection molded onto the outer surface.

In an exemplary embodiment, the first material can be at least one out of the group of the following materials: polyesters (e.g. polyethylene terephthalate, polybutylene terephthalate), polyamide (PA), polysulfone (for example, PES), polyetherimide (PEI), polyphenylene sulfide (PPS), polyether ether ketone (PEEK), polyphthalamide (PPA), polypropylene (PP), polyoxymethylene (POM), phenol formaldehyd (PF), unsatured polyester (UP), polyurethane (PUR and PU). The first material may include at least one filler material out of the group of the following filler materials: Polyamide, polyimide, polyester, polyvinyl alcohol, polyvinylidene chloride, polyacrylonitrile, polyurethane, polyalkylene paraoxybenzoate, phenol type, wool, silk, cotton, rayon, cellulose acetate, flax, ramie, jute, aramid fibres, glass, sepiolite, potassium titanate, ceramic, alumina, calcium silicate, rock wool. The second material may be at least one out of the following material groups: thermoplastic elastomers (TPE), thermoplastic polyurethanes (TPU), epoxies or polyurethane (PUR or PU). A third material may be filled in a space delimited by at least two ribs. Alternatively or in addition, the third material can be used to coat the side surface (wall) of the insulator disc and/or the ribs. The third material may be at least one out of the group of: thermoplastic elastomers (TPE), thermoplastic polyurethanes (TPU), polyurethane (PUR or PU) or Silicones. For economic manufacturing of the insulator the first material can be at least one out of the group of the following materials: a polyester (for example, PET, PBT), a polyamide (PA), a polyphtalamide (PPA), a polypropylene (PP), a polyoxymethylene (POM), phenol formaldehyd (PF), unsatured polyester (UP) or polyurethane (PUR and PU). For high thermal stability, at least one out of the group of the following polymers can be preferred: polysulfone (for example, PES), polyetherimide (PEI), polyphenylene sulfide (PPS) or a polyether ether ketone (PEEK).

For the purposes of illustrating the disclosure, there are shown in the drawings several exemplary embodiments in which like numerals represent similar parts throughout the several views of the drawings, it being understood, however, that the disclosure is not limited to the specific methods and instrumentalities disclosed.

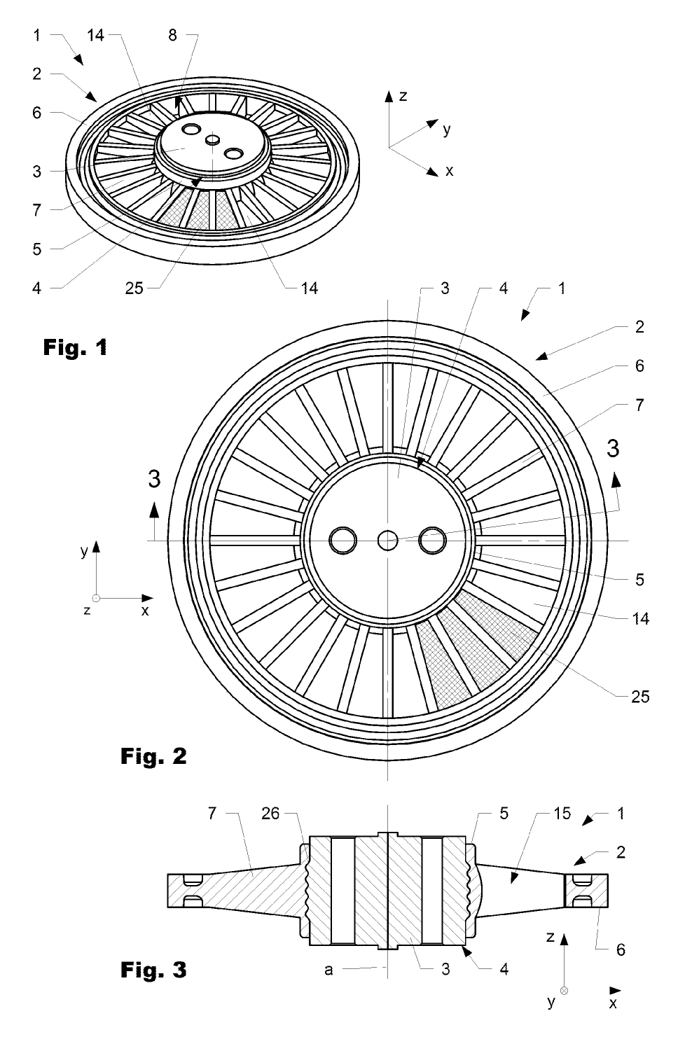

FIG. 1 shows an exemplary embodiment of an insulator 1 according to the present disclosure in a perspective view. FIG. 2 shows the insulator according to FIG. 1 in a front view and FIG. 3 shows the insulator 1 in section view along section line 3-3 according to FIG. 2.

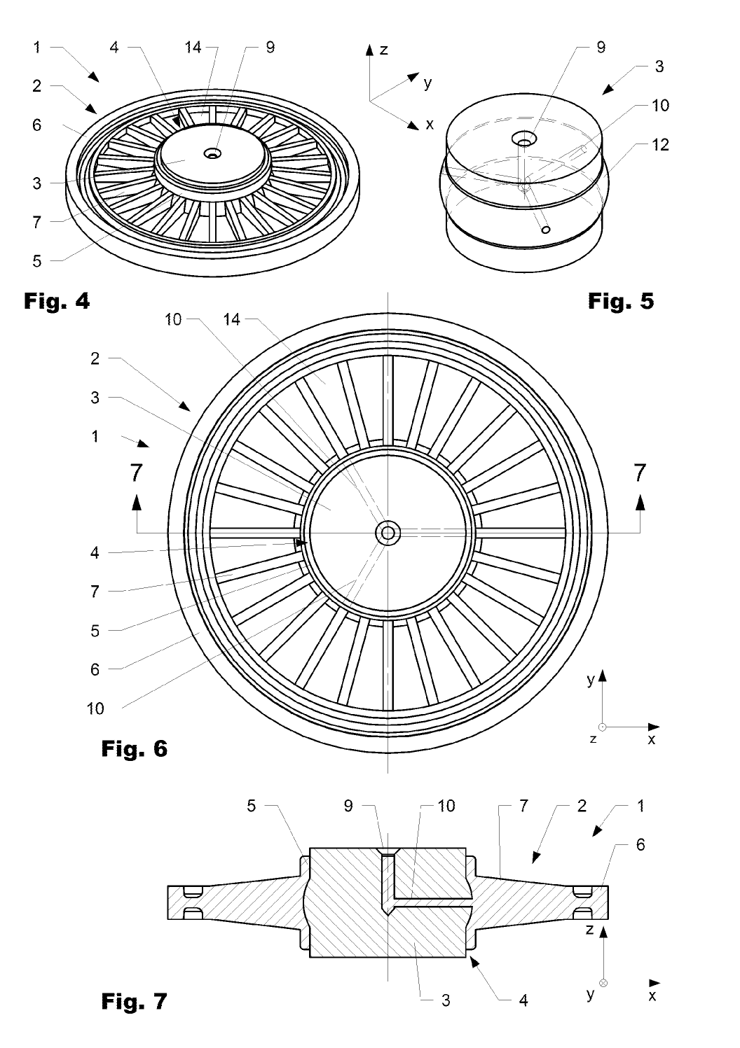

FIG. 4 shows an exemplary embodiment of an insulator 1 according to the present disclosure in a perspective view. FIG. 5 shows a conductor 3 in a perspective view. FIG. 6 shows the insulator 1 according to FIG. 4 in a front view and FIG. 7 shows the insulator 1 in section view along section line 7-7 according to FIG. 6. The section view reveals that a locking means in between the insulator disc 2 and the conductor 3 can be achieved in that the latter includes a bulge extending circumferentially and radially on the shell surface of the conductor. After injection molding of the insulator body/disc, the insulator body/disc features in its center opening a shape being the negative to the bulge such that a good form fit in between the conductor and the insulator disc is achievable.

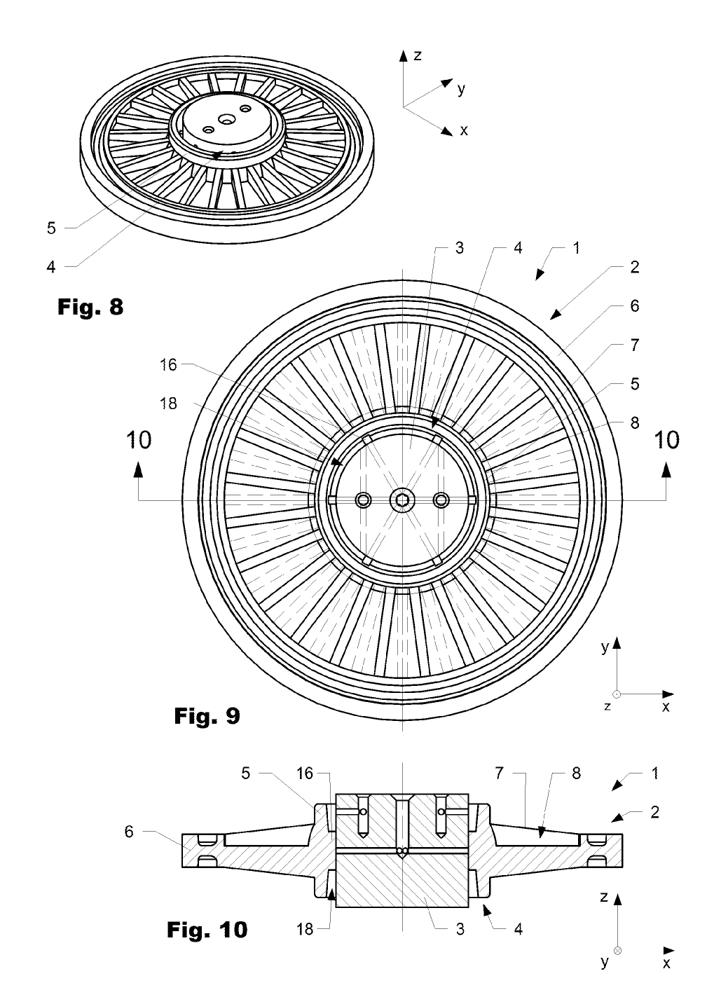

FIG. 8 shows an exemplary embodiment of an insulator 1 according to the present disclosure in a perspective view. FIG. 9 shows the insulator 1 according to FIG. 8 in a front view and FIG. 10 shows the insulator 1 in section view along section line 10-10 according to FIG. 9.

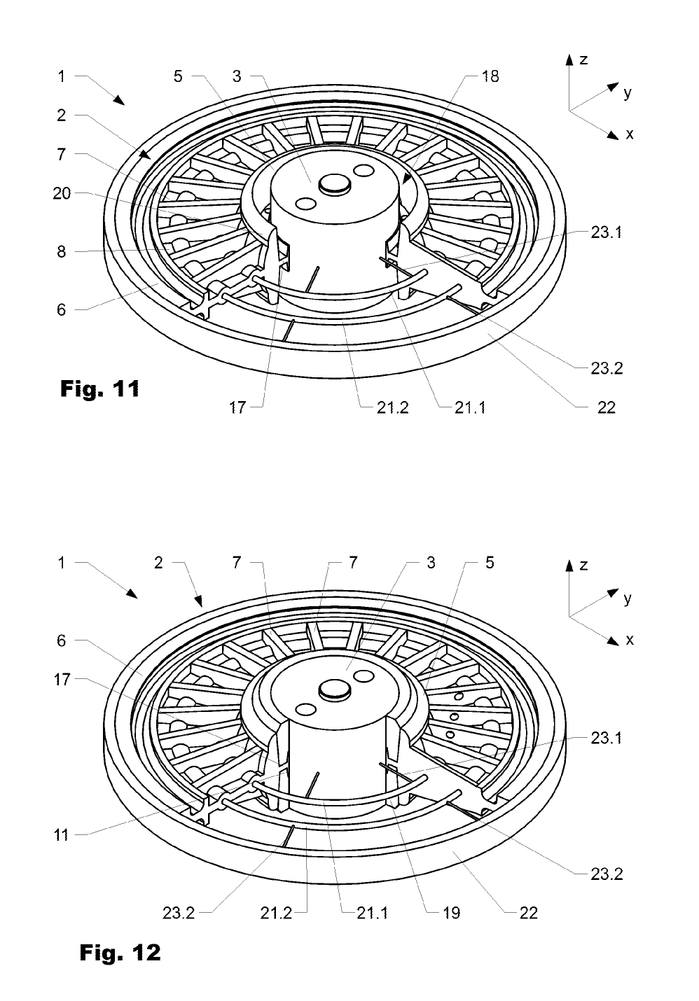

FIG. 11 shows an exemplary embodiment of an insulator 1 according to the present disclosure in a perspective view and in partially cut manner such that the inside of the insulator 1 becomes visible. FIG. 12 shows the insulator according to FIG. 11 and including a second material component as will be described in more detail subsequent.

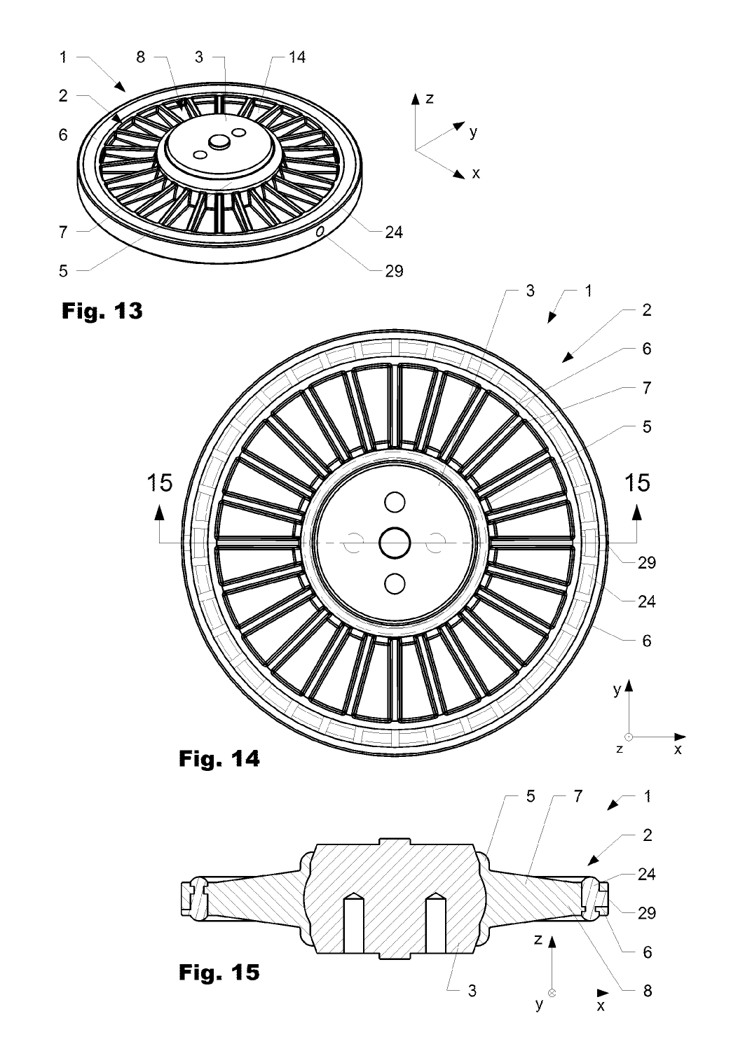

FIG. 13 shows an exemplary embodiment of an insulator 1 according to the present disclosure in a perspective view. FIG. 14 shows the insulator according to FIG. 13 in a front view and FIG. 15 shows the insulator 1 in section view along section line 15-15 according to FIG. 14.

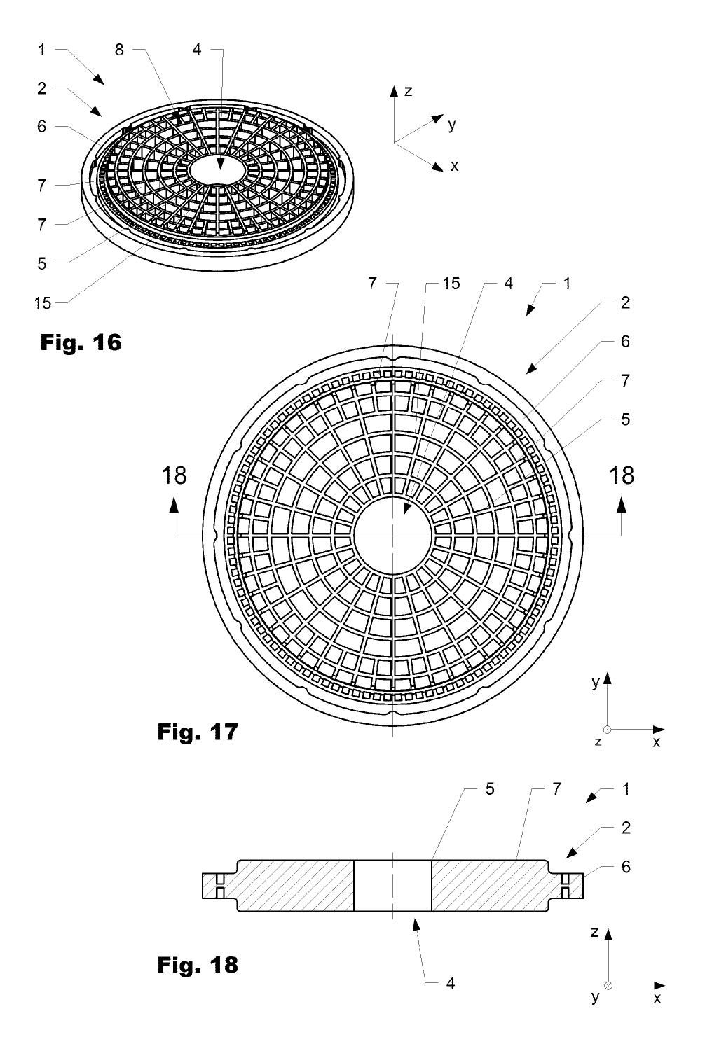

FIG. 16 shows an exemplary embodiment of an insulator disc 2 according to the present disclosure in a perspective view. FIG. 17 shows the insulator disc 2 according to FIG. 16 in a front view and FIG. 18 shows the insulator disc 2 in section view along section line 18-18 according to FIG. 17.

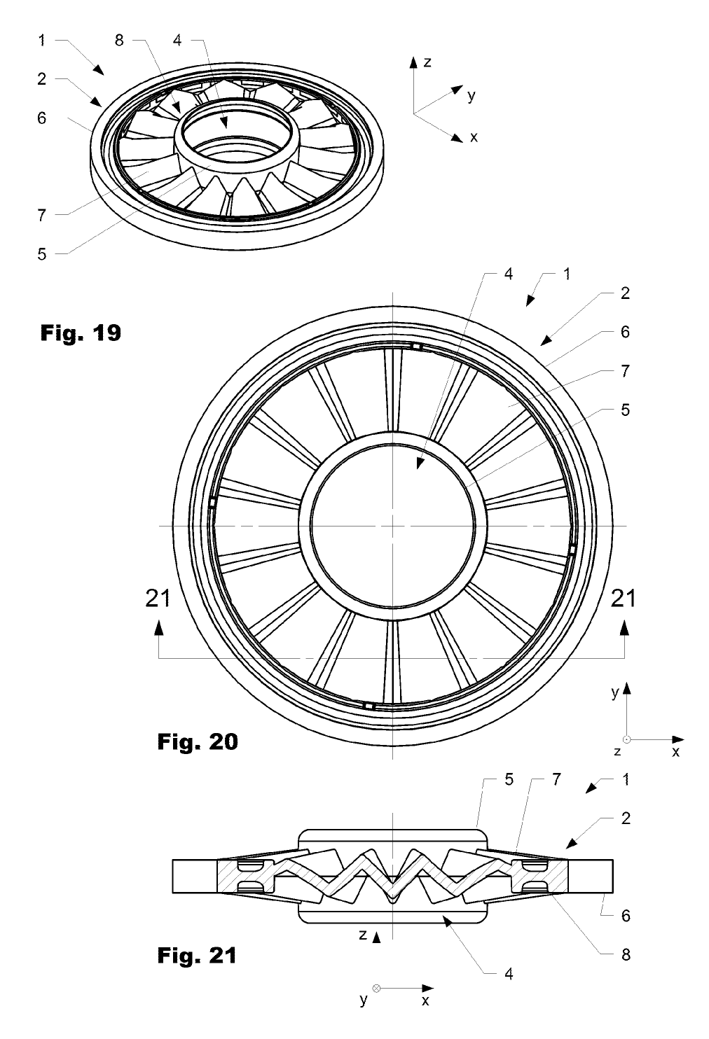

FIG. 19 shows an exemplary embodiment of an insulator disc 2 according to the present disclosure in a perspective view. FIG. 20 shows the insulator disc 2 according to FIG. 19 in a front view and FIG. 21 shows the insulator disc 2 in section view along section line 21-21 according to FIG. 20.

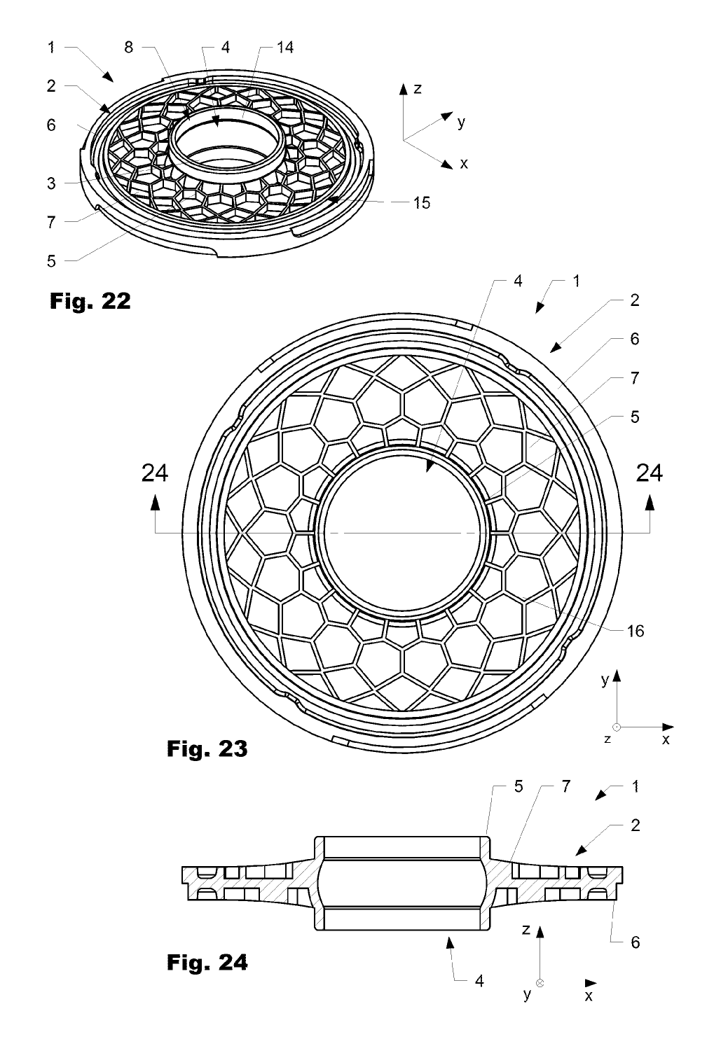

FIG. 22 shows an exemplary embodiment of an insulator disc 2 according to the present disclosure in a perspective view. FIG. 23 shows the insulator disc 2 according to FIG. 22 in a front view and FIG. 24 shows the insulator disc 2 in section view along section line 23-23 according to FIG. 23.

The insulator 1 according to the present disclosure can include a conductor 3, which can be arranged in a center opening 4 of an insulator disc 2. The insulator disc 2 can include an inner bead 5 and an outer bead 6, which can delimit the insulator disc 2 with respect to the inside and to the outside. The inner and/or the outer bead 5, 6 may be strut by radial reinforcement ribs 7 to increase the mechanical stability of the insulator disc 2. The radial reinforcement ribs 7 can be arranged protruding on at least one side above a wall 14.

The insulator discs 2 of the shown embodiments can be made by injection molding of a first material. The injection molding process can be performed in one or several steps whereby the conductor 3 can be placed inside of a mold (not shown in detail) for the injection molding process of the insulator disc 2. The mold can include an adapter, which can be configured to receive and hold a conductor during the injection molding process. The adapter can be designed exchangeable such that different conductors can be processed with the same mold or the same adapter can be used in different molds for the production of different insulator discs 2. For injection molding of the at least one material the mold may include appropriate means, for example, in the form of appropriate connection channels, to interconnect to at least one of the channels arranged in the conductor. Alternatively, or in addition, the mold can be designed such that the conductor can be directly accessible from the outside, for example, the mold can include an opening through which the conductor, respectively the channels arranged in the conductor, can be accessible from the outside when the conductor is arranged inside of the closed mold.

The insulator disc 2 can be injection molded onto the conductor 3. The conductor 3 and the insulator disc 2 can be at least partially spaced apart by a gap 18, which can be at least partially filled with a second material to form a transition means

The exemplary embodiment of the insulator 1 as shown in the FIGS. 1 through 3 includes an insulator disc 2 with an inner bead 5 and an outer bead 6. The inner bead 5 surrounds a center opening 4 in which a conductor 3 is arranged in a coaxial manner. The insulator disc 2 can be injection molded onto the conductor 3 providing a firm bonding between the interacting surfaces. The interacting surface of the conductor 3 can be coated by an appropriate material and/or undertaken a surface treatment to increase the bonding process. As it can be seen in the section view according to FIG. 3 the conductor 3 can include teeth 26, which form fit with the insulator disc 2.

In this exemplary embodiment the inner and the outer bead 5, 6 are strut by radial reinforcement ribs 7, which can be evenly distributed in circumferential direction. As it can be seen in FIG. 3, the radial reinforcement ribs 7 have a conical shape with a thickness, which is decreasing in radial direction. The radial reinforcement ribs 7 can be arranged perpendicular to a center axis a. The ribs 7 can be arranged at an angle (for example, in a skew manner) with respect to the center axis a. Between the radial reinforcement ribs 7 a wall 14 can be arranged in circumferential direction. The wall 14 can be omitted and replaced by an opening (cross port) 15. The cross port 15 can help prevent that the two adjacent sections of the gas insulated device are hermetically sealed with respect to each other. The space between two reinforcement ribs can be at least partially filled with filler 25 made out of a third material (schematically indicated by hatched area) as mentioned above. The complete side surface or only specific parts of it can be covered by the third and/or a fourth material.

The exemplary embodiment of the insulator 1 as shown in the FIGS. 4 through 7 in general corresponds to the exemplary embodiment as mentioned above and shown in FIGS. 1-3. The exemplary embodiment includes an insulator disc 2 which is injection molded onto the conductor 3.

For making of an insulator 1 the following steps can be executed:

a. providing a mold with a cavity, which at least partially corresponds to the insulator disc 2 for injection molding of the insulator disc 2 as shown and described;

b. arranging inside the of the mold a conductor 3;

c. injecting of a first material into the mold to form the insulator disc 2, such the conductor 3 is positioned inside of the center opening 4 and the inner bead 5 of the insulator disc 2 and the conductor 3 are firmly inter-connected directly or indirectly; and

d. removing of the insulator disc 2 and the conductor 3 from the mold.

In the shown embodiment the conductor 3 includes an injection opening 9 which is interconnected to first distribution channels 10.1 which serve during making of the insulator disc 2 to distribute the material injected through the injection opening 9 into the cavity of the mold (both not shown in detail). Thereby it can be achieved that the insulator disc has a uniform surface without surfaces in homogeneities caused by common injection nozzles.

As it can be seen in FIGS. 5 and 6 the first distribution channels 10.1 here have a star-like arrangement. An increased number of first distribution channels 10.1 may support the uniform distribution of the material during the injection molding process. For manufacturing of the insulator disc 2 the conductor 3 can be positioned in the mold (not shown in detail) which normally is at least partially a negative of the final insulator disc 2 to be made, then the mold is closed and first material is injected in liquid form through the injection opening 9 into the distribution channels 10.1 until the mold to form the insulator disc 2 is sufficiently filled. Before the first material is injected, the conductor 3 can be heated until a certain temperature is achieved, which can improve the results of the injection molding process. After the material has cured the mold is opened and the conductor 3 and the insulator disc 2 are removed. The insulator disc 2 can be made in multi-stage injection molding process whereby the insulator disc 2 can be build up in several stages. The conductor 3 may be equipped with further distribution channels, which can be used to inject at least one further material.

The conductor 3 of the exemplary embodiment according to FIGS. 8 through 10 is also used to inject the first material to form the insulator disc 2 at least partially. The conductor 3 therefore includes an injection opening 9 and first distribution channels 10.1 to which an injection nozzle (not shown in detail) can be connected for injecting of the first material to form the insulator disc 2 as described below. As it can be seen in FIG. 9, the distribution channels 10.1 can have a star-like arrangement each having the same length with respect to the injection opening 9. The distribution channels 10.1 can be aligned to axial holding ribs 16 through which the material injection takes place during the manufacturing step. This supports the uniform distribution of the material during the injection molding process of the insulator disc 2. For manufacturing of the insulator disc 2, the conductor 3 can be positioned in a mold (not shown in detail) which normally is at least partially a negative of the final insulator disc 2 to be made, then the mold is closed and first material is injected in liquid form through the injection opening 9 into the distribution channels 10.1 until the mold to form the insulator disc 2 is sufficiently filled. The first material can enter into the mold through the holding ribs 16. Before the first material is injected the conductor 3 can be heated until a certain temperature can be achieved, which can improve the results of the injection molding process and prevents unwanted freezing of the first material. After the first material has cured, the mold can be opened and the conductor 3 and the insulator disc 2 can be removed. The insulator disc 2 can be made in multi-stage injection molding process whereby the insulator disc 2 can be build up in several stages. As visible in FIGS. 9 and 10, the conductor 3 may be equipped with second distribution channels 10.2, which can be used to inject the second material in a gap 18 to form a transition means 19 between the insulator disc 2 and the conductor 3. The second distribution channels 10.2 can be avoided and the transition means 19 can be made by adding the material in a different way, for example by a robot or manually.

In the center opening 4 of the fourth embodiment according to FIGS. 11 and 12 a holding means in the form of a circumferential holding rib 17 is visible which on the inner end merges into a thickening 11 inside which the conductor 3 can be positioned and held as shown in FIG. 11. In axial direction above and below the circumferential holding rib 17, the gap 18 can extend which is filled by the second material as shown in FIG. 12 to form the transition means 19. The holding means may include at least one lateral 20.

If appropriate the conductor 3 can include first and/or second distribution channels to injection molding of plastic material in the sense of the embodiment shown above. If first distribution channels are present they can be interconnected to the thickening 11 which acts as a circumferential channel to distribute material in circumferential direction and to uniformly distribute the material through gap formed in the mold in the area of the circumferential rib 17 which acts as a nozzle to introduce and uniformly distribute the material in the insulator disc 2.

In the exemplary embodiment according to FIGS. 11 and 12, the insulator disc 2 can be encompassed by an outer ring 22 made out of a conductive material. Examples for suitable materials can be a ferromagnetic alloy or a polymer with a carbonaceous content. Two field control elements 21.1, 21.2 can be embedded in the insulator disc 2. The inner field control element 21.1 can be electrically interconnected by an inner connecting element 23.1 to the conductor 3. The outer field control element 21.2 can be electrically interconnected by an outer connecting element 23.2 with the outer ring 22.

The exemplary embodiment according to FIGS. 13 through 15 in general corresponds to the other embodiments mentioned above. As it can be seen in the section view according to FIG. 15 the insulator disc 2 can include a seal 24, which penetrates the insulator disc 2 through axial openings 28 in the insulator disc 2. The seal 24 can be made by an injection molding process. Therefore, the insulator disc 2 can be placed in an injection mold and a third or a fourth material can be injected to form the seal. In the shown embodiment, the material for the seal may be injected through a radial opening 29 in the outer bead 6.

FIGS. 16 through 18 are showing an exemplary embodiment of an insulator disc 2 suitable to be used in an insulator 1 according to the herein described disclosure. The insulator disc 2 can have generally, the same design as the foregoing insulator discs 2. Regarding to the general explanations it is therefore referred to those. The insulator disc 2 can be made by injection molding of a first material. It includes radial and circumferential reinforcement ribs 7, 30. The circumferential reinforcement ribs 30 can be arranged coaxial between the inner and the outer bead forming closed circles. Some of the radial reinforcement ribs 7 interconnect the inner and the outer bead 5, 6. Other radial reinforcement ribs 7 can have a shorter design and extend in the outer region of the insulator disc 2 between the outer bead 6 and a circumferential reinforcement rib 30. The shown insulator disc can be for insulators having a relatively large diameter. As it can be seen the radial and the circumferential reinforcement ribs 7, 30 can all have the same thickness in axial direction, which is only reduced in the region of the outer bead 6. Between the reinforcement ribs 7, 30 a wall 14 can extend which prevents leaking. At least one cross port (not shown in detail) can be configured for exchange of insulator gas as mentioned above.

FIGS. 19 through 21 are showing an exemplary embodiment of an insulator disc 2 suitable to be used in an insulator 1 according to the herein described disclosure. The insulator disc 2 can have in general the same design as the foregoing insulator discs 2. Regarding to the general explanations it is therefore referred to those. The insulator disc 2 can be made by injection molding of a first material. As it can be seen in FIG. 21 the axial reinforcement ribs 8 can have a wave-like cross-section, which can offer the advantage that the side surfaces 8.1, 8.2 can easily be cleaned especially during assembly of the device. Furthermore the reinforcement ribs can offer a high mechanical durability and a low material consumption. The material during injection molding can also be equally distributed.

FIGS. 22 through 24 are showing an exemplary embodiment of an insulator disc 2 suitable to be used in an insulator 1 according to the herein described disclosure. The insulator disc 2 can have in general the same design as the foregoing insulator discs 2. Regarding to the general explanations it is therefore referred to those. The insulator disc 2 can be made by injection molding of a first material. The reinforcement ribs 7 can have a comb-like design, which supports the distribution of the occurring forces.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF DESIGNATIONS

a: Center axis
1: Insulator
2: insulator disc
3: Conductor
4: Center opening
5: Inner bead
6: Outer bead
7: Reinforcement rib
8.1: First Side surface (insulator disc)
8.2: Second Side surface (insulator disc)
9: Injection opening
10.1: First distribution channel
10.2: Second distribution channel
11: Distribution chamber/circumferential channel
12: Outer surface (conductor)
13: Distribution opening
14: Wall (between ribs)
15: Cross port (opening)
16: Axial rib (holding means)
17: Circumferential rib (holding means)/Nozzle
18: Gap
19: Transition means/Adhesive material Lateral opening
21.1: Inner field control element/conductor
21.2: Outer field control element/flange
22: Flange (outer ring)
23.1: Connecting element (field control element/conductor)
23.2: Connecting element (field control element/flange)
24: Seal
25: Filler (Material filled in between ribs)
26: Teeth (Locking element)

What is claimed is:

1. An insulator for a gas insulated device, the insulator comprising:
an injection molded insulator disc; and
a conductor, the insulator disc including a center opening encompassed by an inner bead inside which the conductor is arranged and an outer bead encompassing the insulator disc, and wherein the insulator disc is formed of a first material which is injection molded onto the conductor.

2. The insulator according to claim 1, wherein the insulator disc is directly injection molded onto an outer surface of the conductor; and/or
an intermediate layer is arranged between the conductor and the insulator disc.

3. The insulator according to claim 1, wherein the conductor includes teeth, which are configured to be directly or indirectly engaged with the insulator disc.

4. The insulator according to claim 1, comprising:
a gap configured to distance the inner bead from the conductor and a transition means arranged in the gap configured to interconnect the inner bead and the conductor.

5. The insulator according to claim 4, wherein the transition means is formed of a second material.

6. The insulator according to claim 4, comprising:
a holding means arranged inside the gap configured to position the conductor with respect to the insulator disc, wherein the holding means is at least one of the following:
a circumferential rib, at least three axial ribs, or a shoulder configured to form a mechanical stop for delimiting axial movement of the conductor with respect to the insulator body in one direction.

7. The insulator according to claim 5, wherein the holding means is integrally connected to the insulator disc.

8. The insulator according to claim 1, comprising:
at least one first distribution channel arranged within the conductor, which is configured to receive the first material during the injection molding process; and/or
a bridge element configured to uniformly distribute the first material during injection molding of the insulator disc, wherein the bridge element is arranged between the first distribution channel and the inner bead, and a circumferential channel arranged on the inside of the bridge element and configured to distribute the first material in a circumferential direction during injection molding of the insulator disc.

9. The insulator according to claim 1, comprising:
at least one second distribution channel arranged within the conductor by which a second material configured to form a transition means is injectable after injection molding of the insulator disc; and/or
wherein the transition means is configured to be mechanically interconnected to the insulator disc and/or the conductor.

10. The insulator according to claim 1, wherein the inner bead and/or the outer bead is a strut formed by a plurality of ribs arranged on at least one of a first side surface and a second side surface of the insulator disc; and
the plurality of ribs is arranged in a radial direction.

11. The insulator according to claim 10, wherein the plurality of ribs interconnects the inner bead and the outer bead, and a thickness of the plurality of ribs differs from a thickness of the wall by a maximum of 20%; and/or
at least one cross-port extending in an axial direction such that a first side surface and a second side surface of the insulator disc are connected to one another.

12. The insulator according claim 10, wherein the plurality of ribs on a first side surface and on a second side surface of the insulator disc are arranged circumferentially displaced from one another such that the plurality of ribs are arranged alternatively with respect to the insulator disc in a circumferential direction.

13. The insulator according to claim 1, comprising:
at least one field control element configured to be embedded in the insulator disc; and/or
wherein the transition means is made out of or includes an electrically conductive material configured to act as a field control element in an operating state of the insulator; and/or
wherein the first material comprises at least one material selected from the group of the following materials: PET, PBT, PA, PES, PEI, PPS, PEEK, PPA, PP, POM, PF (phenol formaldehyd resin), UP (unsatured Polyester), PUR; and/or
wherein the first material comprises at least one filler material selected from the group of the following filler materials: polyamide, polyimide, polyester, polyvinyl alcohol, polyvinylidene chloride, polyacrylonitrile, polyurethane, polyalkylene paraoxybenzoate, phenol type, wool, silk, cotton, rayon, cellulose acetate, flax, ramie, jute, aramid fibres, glass, sepiolite, potassium titanate, ceramic, alumina, calcium silicate, rock wool; and/or
a space delimited by the at least two ribs, which is at least partially filled with a third material; and/or
wherein the insulator disc is at least partially coated by a fourth material; and/or
at least one seal, which is joined to the insulator disc by injection molding of the at least one seal onto the insulator disc.

14. The insulator according to claim 5, wherein the second material comprises at least one material selected from the group of the following materials: TPE, TPU, Epoxy, PUR.

15. The insulator according to claim 1, in combination with a medium voltage or high voltage switchgear.

16. The insulator according to claim 15, wherein the medium voltage or high voltage switchgear is gas insulated and configured such that an insulation gas is at least partially contacting the insulator disc.

17. A mold for producing the insulator according to claim 1, wherein the mold includes a cavity and an adapter for receiving and temporarily holding the conductor during injection molding of the insulator disc, which includes the inner bead surrounding the center opening, and wherein the adapter is part of a cavity of the mold such that the adapter is least partially in contact with the injection molded material during injection molding of the insulator disc.

18. The mold according to claim 17, wherein the conductor includes an injection opening that is interconnected to first distribution channels, the channels being arranged for distributing a first material injected through the injection opening into the cavity of the mold during the injection molding of the insulator disc, wherein the injection opening of the conductor is accessible from outside the mold.

19. A method for the production of an insulator, the method comprising:
providing a mold for injection molding of an insulator disc, the insulator disc comprising an inner bead surrounding a center opening;
arranging a conductor in a cavity of the mold;
injecting a first material into the mold to form the insulator disc, wherein the conductor is positioned inside of the center opening and the inner bead of the insulator disc and the conductor are firmly interconnected directly or indirectly; and
removing of the insulator disc and the conductor from the mold.

20. The method according to claim 19, comprising:
injecting the first material through at least one channel arranged inside the conductor; and/or
heating the conductor to a predetermined temperature before the first material into the mold; and/or
performing the injection of the first material into the mold in at least two shots.

21. A method for making of an insulator disc, the insulator disc having a center opening and an inner bead and an outer bead, and a conductor arranged in the center opening of the insulator disc, the method comprising:
providing an injection mold, the injection mold having a first mold half, a second mold half interacting with the first mold half along a parting plane, a cavity corresponding to the insulator encompassed by the first and the second mold half, and at least one injection nozzle arranged at the first mold half configured to discharge liquefied material into the cavity directly or indirectly;
closing the mold by relative movement of the first with respect to the second mold half until the cavity is closed;
injecting liquefied material through the at least one injection nozzle;
opening the mold by relative movement of the first with respect to the second mold half; and
removing the insulator from the mold cavity.

22. The method according to claim 21, wherein providing in the mold at least one adapter configured to receive and temporarily hold a conductor during injection molding of the insulator disc and, before injecting liquefied material into the cavity, opening the mold by relative movement of the first mold half with respect to the second mold half in a first direction and attaching a conductor to the at least one adapter; and/or
wherein at least one part of the mold is configured to be movable to reduce the volume of the cavity and which is configured to compress the material in the cavity after and/or during injection of the liquefied material.
